(19) United States
(12) Patent Application Publication
(10) Pub. No.: US 2005/0034974 A1
(43) Pub. Date: Feb. 17, 2005

(54) Means and method for improving performance and production using purified water

(76) Inventor: Takeo Kagitani, Tokyo (JP)

Correspondence Address: Ward & Olivo, 708 Third Avenue, New York, NY, 10017, US

(21) Appl. No.: 10/890,815

(22) Filed: Jul. 12, 2004

Related U.S. Application Data
(63) Continuation-in-part of application No. 10/012,258, filed on Oct. 29, 2001, now Pat. No. 6,805,775.
Application No. 10/012,258 is a continuation-in-part of application No. 09/344,599, filed on Jun. 25, 1999, now Pat. No. 6,310,266.
Application No. 09/344,599 is a continuation of application No. 09/060,473, filed on Apr. 15, 1998, now Pat. No. 5,985,101.

(51) Int. Cl. H05F 3/00; B01J 19/08

(52) U.S. Cl. 204/164; 422/186.04

(57) ABSTRACT

Disclosed is a method and device for purifying water and advantageous uses of such purified water. Such purified water enhances the yield of crops as well as the performance of gasoline for automobiles. For example, when raising fruits and vegetables, the harvest may be increased by up to thirty percent. Also, addition of about three parts per thousand of the water purified by the present invention to gasoline increases the distance a car may travel. More specifically, water is purified according to the present invention by utilizing high-voltage electricity in conjunction with large surface charcoal, an electrical wire, ordinary tap water, and optionally, a small amount of iron sulfide.

### CROSS-REFERENCE TO RELATED APPLICATIONS

This application is a continuation-in-part of application Ser. No. 10/012,258, filed on Oct. 29, 2001, now U.S. Pat. No. ______.

### TECHNICAL FIELD OF THE INVENTION

The present invention relates generally to an improved method and apparatus for providing purified water by removing harmful substances (i.e., toxins) therefrom. Preferably, the toxin-free water is attained by utilizing high-voltage electricity in conjunction with large surface charcoal and water. In particular, a mixture of gasoline and water purified according to the present invention, when combusted, significantly improves gasoline performance and efficiency in automobiles as compared to the combustion of conventional gasoline only. In addition, the application of water purified in accordance with the invention to plants significantly increases growth and production as compared with watering with conventional water.

### BACKGROUND OF THE INVENTION

Among the techniques available for improving the performance of gasoline include mixing gasoline with additives, such as methyl tertiary butyl ether (“MTBE”). MTBE is derived from nonrenewable resources, such as natural gas, coal, or other oil refinery products. Specifically, MTBE is added to gasoline as an octane booster to increase engine performance and meet oxygenate levels mandated by the 1990 Clean Air Act Amendments. However, despite the obvious benefits, MTBE is resistant to biodegredation, has been shown to contaminate groundwater, is detrimental to human health and is a possible carcinogen.

To avoid the hazards associated with MTBE, other, more environmentally-friendly additives have largely supplanted MTBE in gasoline. More recently, ethanol has been added to gasoline which also increases octane levels and meets the requirements mandated by the 1990 Clean Air Act. Ethanol is a biodegradable renewable resource and significantly less toxic than MTBE. However, most ethanol is derived from corn which places stress on the environment through the depletion of soil nutrients and through the use of pesticides and fertilizers. Other additives for the improved performance of fuels are also known and disclosed.

On such disclosure describes a composition comprising a fuel oil (e.g., gasoline), ethanol, small amounts of water, and a stabilizing amount of an additive. The additive is substantially insoluble in water, but soluble in a gasoline-ethanol mixture. This additive prevents the separation of the gasoline-ethanol mixture into distinct phases. However, the water and stabilizer do not serve to improve the performance of gasoline, but merely stabilizes a gasoline-ethanol mixture.

Another discloses a gasoline additive which remains liquid at low temperatures and contains a fatty acid, ester, or mixtures thereof, in combination with an alcohol, amine, or mixture thereof. The additives act to produce a homogeneous, low viscosity fluid which is suitable for tack injection, but do not improve the performance of a tank of gasoline without additives.

Yet another also discloses an additive for use in fuels, especially in gasoline for use in internal combustion engines. The additive (i.e., a friction modifier) enables the formulation of a stable additive without the need for an additional solubilizing agent for the friction modifier. In addition, the friction modifier achieves a significant benefit in friction loss and also shows an improvement in fuel economy. However, such a friction modifier (e.g., n-butylamine oleate) is not as readily available as water, or even purified water.

Still another teaches a fuel additive composition including a C₁-C₄ alcohol and an ether compound selected from the group consisting of dialkoxyalkanes, alkoxyalcohols, trialkoxyalkanes, dialkoxycycloalkanes, and aryl alkyl diethers. Such additives serve to increase the octane level of the fuel without detrimentally affecting the environment. While these additives may improve fuel economy, the materials used are not as readily available as water.

Aside from needed improvements to gasoline, improvement in the farming industry is also possible. Presently, many farmers use irrigation systems to water their fields. The water feeding these irrigation systems may come from local waterways or wells. As taught in the known art, this water may be treated before being applied to the field. For example, one such method includes a mixing system for dissolving a water-soluble additive into irrigation water via a venturi system. The additive, typically an agriculturally-beneficial polymer, is thoroughly mixed with water before application to a field of crops.

Another discloses a method to treat crops using an irrigation solution that inhibits surface pathogens, improves water penetration and increases crop production. Specifically, this method produces a gaseous solution of ionized air and effects direct contact between the ionized gaseous mixture and a supply of water. The treated water is then applied to crops to prevent surface fungus.

Another describes a system and method for treating irrigation water. Here, feed gas, formed from ozone and other molecules, is injected into the water to be treated. This method produces nitrogen-containing compounds for use as a fertilizer.

Still another method teaches an automated system for providing a continuous yield of agricultural produce. Once again, additives are used in irrigation water to increase production. Specifically, oxygen is dissolved in irrigation water and applied to plant roots to increase growth.

In contrast to other prior art methods, yet another discloses a method for purifying water for use on plants. This method involves condensing water vapor in the air of a greenhouse on the greenhouse walls and then collecting the condensed water at the base of the walls to pass the collected water to the roots of the plants. Unfortunately, this method only works when the plants are grown within a greenhouse structure.

Moreover, natural resources are currently being rapidly depleted by pollution. These resources include water, air, and food. Scientific studies have been done at the Awaji Island Monkey Center where monkeys are fed the same imported foods that humans consume (e.g., wheat corn, soybeans, peanuts, etc.). These studies show that toxins in food cause a high percentage of deformed monkey babies. Currently, there is an increased number of children born with abnormalities of an unknown cause. These abnormalities may be due to agricultural medicines and chemical fertilizers used in crops grown for human consumption. Another factor that may contribute to the abnormalities of human babies is the pollution in the environment. Also, bottled water has become a greatly demanded and inexpensive source of drinking water today. However, bottled water, as presently sold on the market, contains harmful preservatives, perhaps even poisonous preservatives, which allow for long-term storage of water.

Although there are no known methods like the present invention for detoxifying materials, there are known in the art general water purification methods and devices. These consist of methods and devices wherein the liquid (water) is passed, sequentially or in parallel, through inter-electrode gaps formed by flat electrodes, with a constant or pulsating voltage in the range of 3 to 30 volts.

Disadvantages of the above process, resulting from a rather low field intensity, its uniformity and the character of the process hydrodynamics, reside in the deposition of an oxide film on the anode surface, the presence of a concentration polarizing effect, deposit formation on the cathode, increasing equivalent resistance of the inter-electrode space, and the necessity of introducing an oxidizing agent to convert Fe(OH)₂ into Fe(OH)₃.

Another known method for the electric purification and decontamination of liquids comprises passing a liquid through a packed inter-electrode space comprised of metal chips or other metal particles. The metal is arranged in layers that are separated from each other by porous diaphragms. Further, the voltage across the electrodes is less than 100 volts.

A disadvantage of the above-described method is that the porous diaphragm tends to become clogged with metal hydroxide due to limited flake removal. Consequently, increased hydraulic resistance to the flow of liquid occurs. A considerable portion of the flow passes through the packed inter-electrode space without being purified, as the surfaces of the chips in the packing are in a state of mutual electrical contact.

According to another known method, the liquid passes through the inter-electrode space formed by coaxially arranged cylindrical electrodes. The voltage applied to the electrodes is less than 100 volts. A disadvantage of this method includes a low efficiency of dipolophoresis, resulting from low non-uniformity of the electric field and concentration of suspended particles. Intensive deposition of particles on the anode under the conditions of the process impair operation.

Also known in the art is a method for the purification and decontamination of liquids by means of a high-voltage electric discharge wherein a liquid is subjected to electrical discharge. The conditions applied are on the order of 10,000-100,000 volts, over 100 amperes of current, and a pulse duration of 0.1 to 100 microseconds. Heavy losses of electric power, reactance losses, unsatisfactory bactericidal effect, dangerous sounds, as well as the formation of carcinogenic substances all result from this process of purification.

Also known in the art is an apparatus for effecting the purification and decontamination of liquids, which comprises a coagulation chamber having electrodes in the form of flat plates. A disadvantage of this apparatus is its large anode surface. A smooth adjustment of the inter-electrode space is impossible, which results in the formation of an oxide film on the surface of the anode, the appearance of concentration polarization, the formation of deposits on the cathode which increases equivalent resistance of the inter-electrode space and the need to introduce an oxidizer for the purpose of converting Fe(OH)₂ into Fe(OH)₃.

Another known apparatus for effecting the electric purification and decontamination of liquids involves packed electrodes as a bank of cells that are separated from each other by porous diaphragms and arranged between current-conducting electrodes. Problematic to operation, as the process proceeds the packed material tends to dissolve. Special devices are necessary for compressing the packed material and requires the current polarity to be changed.

There is also known an apparatus comprising a coagulation chamber with coaxial cylindrical electrodes. A drawback to this apparatus is the low non-uniformity of the electrical field of the inner large-diameter electrode, which reduces the value of dipolophoretic forces. These forces are independent of the charge of the particles. As a result, it is necessary to provide a pre-setter for removing large particles having low electric charge.

Also known in the art is an apparatus and method for employing a high-voltage electrical discharge for the electric purification and decontamination of liquids. In this apparatus the starting liquid flows through a coagulation chamber wherein at least two rod-type electrodes are disposed inside the housing in such a manner that their longitudinal axes lie in parallel planes, the distance between the planes being within the size of the inter-electrode space. One of the rod-type electrodes is electrically insulated from the housing of the coagulation by means of an insulator.

The electrodes in the apparatus are secured in the housing. Large destruction of insulation of one of the electrodes, a low degree of utilization of the purification volume, the necessity of frequent replacement of one of the electrodes, and the need of having a very high strength housing are among the problems associated with this apparatus.

Briefly, one such disclosure teaches a method for the electric purification and decontamination of liquids containing suspended and dissolved matter (i.e., mineral, organic and biological substances). Passing a pulsating electric current through a starting liquid, the current has sufficient pulse duration and voltage to cause electric discharge between the electrodes. This apparatus comprises a coagulation chamber with at least two rod-type electrodes electrically insulated by individual insulators from the housing of the coagulation chamber and mounted together with their insulators to execute reciprocal motion along their longitudinal axes.

Additionally, the science of affecting and treating fluids by submitting them to magnetic fields has been recognized and used for many years. Magnetohydrodynamics, as the phenomenon is known, is based on the observations and teachings of Michael Faraday. For example, a generator utilizes the electromotive forces created by conductive materials passing between the poles of magnets. According to the Lorentz principle, ions are separated by charge when passing between the poles of a magnet, partially explaining the effects of treating fluids with magnetic fields. Most likely, additional discoveries will be made in the application of magnetic forces to a flowing fluid. Voluminous additional information, well-known in the art, will not be discussed here, but exists with respect to the above teachings.

The element hydrogen, prevalent in, for example, water, is known to be highly susceptible to the influences of magnetic fields. An application of this principle is the processing proton magnetometer that measures the total magnetic intensity of a sample of water or hydrocarbon. Also, magnetic resonance imaging (MRI) is based on the affect of a magnetic field on a proton. Both of these apparatuses measure the energy released by spinning protons after they are aligned by a magnetic field and subsequently disturbed either by the earth's magnetic field or a radio frequency wave propagated toward the sample. Such applications confirm that energy is released when the spinning protons are so affected.

The spinning protons in fluids such as water, alcohol, gasoline, kerosene, and many others act as spinning magnetic dipoles. Under normal circumstances, these protons spin randomly inside their respective atoms. A magnetic field temporarily polarizes and aligns the dipoles. Magnets may be employed to create consistent powerful magnetic fields that align protons and cause them to spin in uniform directions. This alignment and subsequent concentration of energy in a uniform direction results in an attraction between, for example, the hydrocarbon fuel molecule and the oxygen molecule. When used with water, the result is purification and decontamination of water.

However, prior art magnetic fluid treatment devices are typically inefficient in generating a strong magnetic curtain in tile fluid flow path and are frequently limited in the sizes of conduit they can treat. Additionally, existing designs require high-cost manufacturing techniques due to the need for completely different components for each size of conduit. The effectiveness of the magnetic field is, of course, dependent upon the strength of the magnetic field and that strength is also known to be inversely proportional to the square of the distance from the magnetic source. The prior art has been generally ineffective in optimizing the magnetic field strength that may be obtained from a permanent magnet array, and has further been ineffective in treating large systems employing conduits of significant cross-sectional diameter in which large volumes of fluid pass. The prior art also lacks magnetic fluid treatment devices which are modularized to accommodate various fluid flow systems and allows the magnetic treatment of the same to be tailored to a particular system. Additionally, the prior art has typically not proposed magnetic fluid treatment devices which may be either intrusive for implementation with new fluid flow systems, or non-intrusive to be easily added to existing fluid flow systems. By “intrusive”, it is contemplated, according to the present invention, that the magnetic fluid treatment device will be inserted in-line, or in series, with the fluid pathway. Conversely, by “non-intrusive”, it is contemplated that the magnetic fluid treatment device of the present invention will be affixed to the perimeter or exterior surface of the fluid pathway, such as by clamping the magnets around the pipe that is carrying the fluid to be treated.

Applicant has recognized a need for a means and method to improve both gasoline performance and crop yields through using purified water. As discussed above, a need exists for improving the efficiency of gasoline using an environmentally-friendly additive. A need also exists for improving yields of harvests.

### SUMMARY OF THE INVENTION

The present invention provides a revolutionary method for removing toxins from various materials in a water medium by utilizing a combination of a 10,000 volt electric charge and large surface charcoal. For example, pesticides can be removed from fruits and vegetables for safe consumption. Other types of materials that can be detoxified include metals containing ferric oxide, synthetic resins, poisonous gases, etc. Further, items that cannot be submerged in water can still be detoxified. For example, to remove the toxins from dry goods or materials, one can soak a metal wire such as copper in the detoxified water for a short period. After removing the wire and allowing it to dry, simply place the wire and the dried object together in a paper bag and the dried object will be detoxified.

Aside from toxins present in foods, metals and the environment, those toxins and poisons accumulate in the body. Accumulation of toxins may result from consumption of the food and water or from the surrounding environment. Over time, these toxins and poisons can lead to fatigue, illness and a general decline in one's health and well being. This invention is particularly unique in its ability to cleanse a person of toxins through showering or bathing with detoxified water. Ultimately, a person's overall health and mental well-being may be restored in the absence of these poisons and toxins.

Additionally, the present invention discloses a method for purifying liquids passing through a pipe, such as a water pipe leading into a building. That is, an electrical wire that has been electrically charged within a conductive metal container filled with tap water and large surface charcoal is wrapped around a water pipe. Then, the water or other fluids flowing through the pipe will be purified or detoxified (i.e., made free of chemicals and/or toxins).

Then, water purified by the present invention may be used in raising fruits and vegetables to enhance a crop harvest by up to about thirty percent (30%).

In addition, use of the purified water has been found to improve the performance of gasoline used in automobiles. Adding approximately three (3) parts per thousand (1000) of the purified water to gasoline results in the automobile traveling thirty percent (30%) further on flat roads and about fifty percent (50%) further on sloped roads than with conventional gasoline without the purified water.

The purification device of the present invention provides a novel method and apparatus for removing harmful substances (i.e., toxins) from various materials in a water-based medium. Alternatively, the present invention provides an inexpensive, safe, energy efficient alternative to present water purification systems. The method and device of the present invention is easier to maintain than most home-use water purifiers for a variety of reasons, including only replacing the charcoal periodically (i.e., on a yearly basis), production of detoxified objects (i.e., clean food for human consumption, etc.), and small operating power (e.g., approximately 10 micro watts (10,000 Volts*1 Pico Ampere) for an extended period of time ranging from approximately 1 hour to approximately 10 hours).

The present invention achieves the detoxification of various materials by transmitting an electric charge throughout the water purification device. This device comprises a first, smaller container wholly or partially filled with large surface charcoal. This first container is then placed within a second, larger container filled with water. The second container may optionally contain iron sulfide (FeS), which may make the purification more effective. When used, powdered iron sulfide may be added in small amounts, such that it is not necessary to remove the iron sulfide from the water. Since the first container has a plurality of holes, the water flows throughout the first container as well as the second container. The object containing harmful substances or toxins is then immersed in the water in the second container which is then sealed with a cover. A connected electric source then generates and transmits an electric charge to the purification device to “clean” or “detoxify” the object. After an extended period of time, the water and object are removed from the container—purified.

In light of the foregoing, it is an object of the present invention to provide a method of purifying liquid (e.g. water) that passes through a pipe by attaching a wire, that has been electrically charged within a conductive metal container filled with tap water and large surface charcoal to the pipe in order to detoxify or purify the liquid within the pipe.

Another object of the invention is to apply the water purified according to the present invention to crops of fruits and vegetables to increase the harvest yield by approximately thirty percent (30%).

Yet another object of the invention is to improve the fuel economy in a combustion engine by mixing approximately three (3) parts per thousand (1000) of the purified water according to the present invention with gasoline. This may aid a vehicle in traveling approximately thirty percent (30%) further on flat roads and approximately fifty percent (50%) further on sloped roads as compared to a vehicle operating with regular gasoline.

It is yet another object of the invention to provide a novel material detoxification device which utilizes high-voltage electricity in conjunction with large surface charcoal and water to remove toxins from a variety of materials or objects.

Still a further object of the invention provides a material detoxification device which employs a modular design so that additional units can be added if circumstances require, and which further allows for the mounting of the modules to a conduit in a variety of configurations or geometries as circumstances dictate.

Yet an additional object of the invention provides a material detoxification device which may be non-intrusive to accommodate ease of application to existing fluid systems.

A further object of the invention provides a material detoxification device which includes a plurality of parallel devices for treatment of large capacity fluid conduits.

Still a further object of the invention provides a material detoxification device which is reliable and durable in use, and cost effective in implementation through the use of commonly available materials.

Another object of the invention provides a material detoxification device wherein backing plates can be used for either intrusive or non-intrusive designs.

Other objects, features, and characteristics of the present invention, as well as the methods of operation and functions of the related elements of the structure, and the combination of parts and economies of manufacture, will become more apparent upon consideration of the following detailed description, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 shows a device for the removal of harmful substances from various materials or objects in accordance with the present invention; and

FIG. 2 shows the inner container of the device shown in FIG. 1 having a plurality of holes therein in accordance with the present invention.

FIG. 3 depicts an alternate method of purifying liquids using the apparatus of the present invention, wherein a wire, electrically charged within the apparatus shown in FIG. 1, is placed or coiled around a pipe (e.g., a water pipe leading into a building) to purify the fluids flowing through it.

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The following presents a detailed description of a preferred embodiment of the present invention. As discussed above, the present invention relates to a method and apparatus for the purification of materials or objects. More specifically, this invention relates to a device which uses high-voltage electricity in conjunction with large surface charcoal to provide purified materials or objects for the protection of humans and the environment. Alternatively, the device and method also provides purified water for drinking.

The present invention provides a novel device that removes harmful substances (i.e., toxins, contaminants, etc.) from a variety of objects or materials. In addition, the purification (or detoxification) device of the present invention has several novel special features. First, the device incorporates the use of large surface charcoal immersed in water and held in an open inner container. The molecular character of the large surface charcoal effectively passes electrons through the center container and, therefore, contributes to the purification of the object or other material immersed in the water in the outer container. Second, the device uses a high voltage, low current electric power source connected to the outer container which transmits an electric charge to the outer container over a period of time. This electric charge causes the impurities in the ordinary (tap or faucet) water to disappear, thereby purifying the water and objects immersed therein.

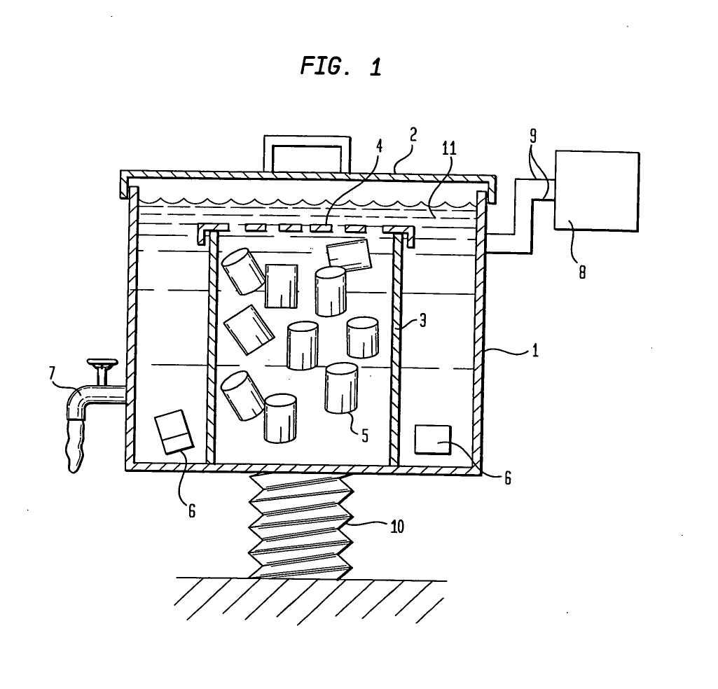

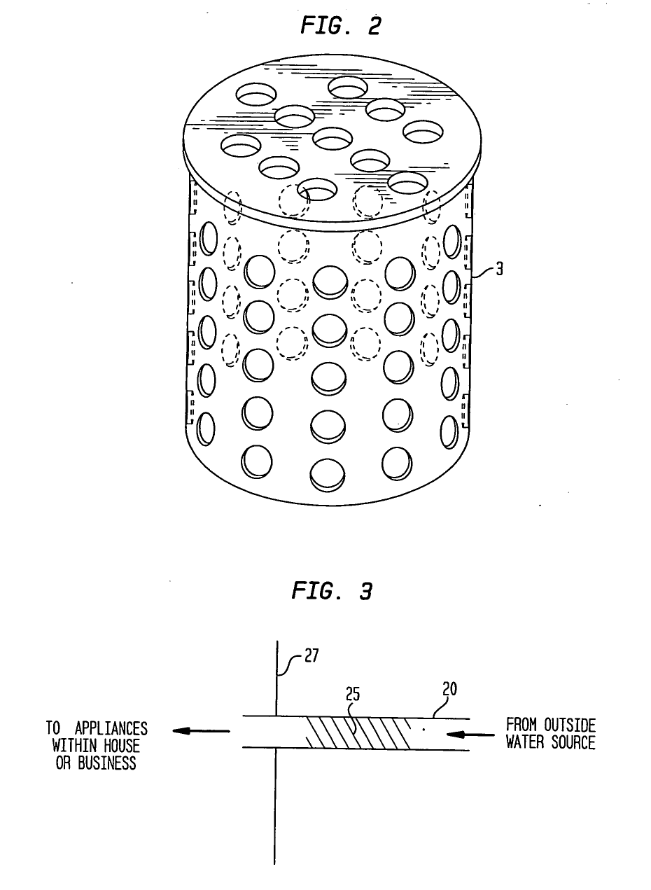

Referring first to FIG. 1, shown is a device for the detoxification (or purification) of materials according to the present invention. This device comprises a first conductive metal container 3, which is filled with ordinary tap water 11 and large surface charcoal 5. Container 3 has a plurality of holes throughout its surface to allow the free flow of water (as well as the electric charge) throughout the device, as shown in FIG. 2. The molecular character of the large surface charcoal provides an effective means for passing electrons through the center container, and therefore detoxifies materials in the outer container. Container 3 also contains a lid with holes and is placed inside a larger, second metal container 1.

Next, the second container 1 is filled with ordinary tap water 11, which also fills container 3, and the contaminated objects or materials 6 which are to be purified and/or detoxified. Second container 1 is then sealed with cover 2. Also, second container 1 is insulated from the supporting surface (i.e., floor or table) with insulating material 10, and comprises spout 7 which provides for the simple and efficient removal of the water from the device of the present invention. In an alternative embodiment, iron sulfide (FeS) may be added to the water in the second container to aid in purification of the water. The second container may optionally contain iron sulfide (FeS), which may make the purification more effective. When used, powdered iron sulfide is added in small amounts, such that it is not necessary to remove the iron sulfide from the water.

Also shown in FIG. 1 is an electric source device 8 which is attached to the device of the present invention. Electric source device 8 generates a 10,000 volt electric charge at 1 picoampere, i.e., 10 microwatts of power. The voltage is transmitted to the second container 1 via electric cables 9 and applied for approximately ten (10) hours. Alternatively, continuous time periods of approximately one (1) hour or five (5) hours have also shown significant purification results. After the time period of electrically charging the water has lapsed, the contaminated materials or objects 6 will be purified or detoxified and ready for use. The water can then be removed through spout 7 and when second container 1 is empty, the entire process can be repeated.

As an alternative use of the preferred embodiment of the present invention as described above, disclosed below is the use of the present invention as a water purification device. Referring again to FIG. 1, shown is a device of the present invention used for the purification of water. Again, the device comprises a first conductive metal container 3 containing large surface charcoal 5 and which is immersed in the ordinary tap water 11 that is to be purified. The molecular character of large surface charcoal 5 provides an effective means for passing electrons through the center container, and therefore contributes to the purification of water in the device. Container 3, which preferably has holes throughout its surface (as shown in FIG. 2) is then covered with lid 4 (also having holes) and placed inside a larger, second metal container 1. Next, second container 1 is sealed with cover 2, insulated from the supporting surface (i.e., floor or table) with insulating material 10, and comprises spout 7 which provides for the simple and efficient removal of the purified water from the device of the present invention. In an alternative embodiment, the second container may also comprise an amount of iron sulfide, which may make the purification more effective. When used, powdered iron sulfide is preferably added to the water in small amounts, such that it is not necessary to remove the iron sulfide from the water.

Attached to the constructed device is electric source device 8. Electric source device 8 generates a 10,000 volt electric charge at 1 picoampere, i.e., 10 microwatts of power, and is transmitted to second container 1 via electric cables 9. This voltage is then applied to the second container for approximately ten (10) hours. Alternatively, continuous time periods of approximately one (1) hour and five (5) hours have also shown significant purification results. After the time period of electrically charging the water has lapsed, the previously contaminated water 11 will have been purified and ready for use. The purified water may be removed through spout 7 and when second container 1 is empty, the entire process can be repeated.

Briefly, in accordance with this invention, electric source device 8 may comprise any source of electric current, including but not limited to ordinary household electric outlets, so long as the electric source used can provide an approximate voltage in the range of 10,000-100,000 volts.

The following tables show results from a test conducted by the Head of Health Sanitation in Minato-Ku, Tokyo, using the device of the present invention. More particularly, Table 1 lists the results of a water quality test showing the chemical components found in the water after being purified by the purification device according to the present invention. Table 2 lists the results of a water quality test showing the physical characteristics of the water after being purified by the purification device according to the present invention.

TABLE 1
Results of the water quality test showing the chemical
components found in the water after being purified by the
purification device according to the present invention.

| | | Purified | |
|---|---|---|---|
| | | Water Using | |
| Items | Units | the Invention | Standard Tokyo Water |
| Nitric Acid | mg/l | 2.0 | 10 |
| Nitrogen/ | | | |
| Nitrous | | | |
| Acid | | | |
| Nitrogen | | | |
| Chlorine | mg/l | 32.4 | 200 |
| Ions | | | |
| Organisms | mg/l | 1.2 l | 10 |
| (Excess | | | |
| Manganic | | | |
| Acid | | | |
| Potassium | | | |
| Consumption | | | |
| Quality) | | | |
| General | | 0 | 100 |
| bacteria | | | |
| Colon | | not detected | not detected |
| bacillus | | | |

TABLE 2
Results of the water quality test showing the physical
characteristics of the water after being purified by the purification
device according to the present invention.

| | | Purified Water | |
|---|---|---|---|
| | | Using the | |
| Items | Units | Invention | Standard Tokyo Water |
| Smell | | no abnormality | no |
| | | | abnormality |
| Taste | | no abnormality | no |
| | | | abnormality |
| Color | degrees | 1 | 5 |
| Turbidity | degrees | 0 | 2 |
| Iron | mg/l | 0.05 | 0.3 |
| pH Value | | 7.0 | ˜8.6 |

Referring first to Table 1, depicted are the results of tests performed on ordinary Tokyo tap water using the water purification and/or material detoxification device of the present invention. For this testing, water samples were collected from 308 Mano-Nogizaka, 8-12-30 Akasaka, Minato-Ku, Tokyo on Jan. 28, 1997, and testing began on Jan. 28, 1997, to determine the effect of the device according to the present invention on the quality of ordinary faucet water. More specifically, Table 1 shows the numerical values of nitric acid nitrogen, nitrous acid nitrogen, chlorine ions, organisms (excess managanic acid potassium consumption quality), general bacteria, and colon bacteria before and after the purification of the water using the device of the present invention. Accordingly, all levels of these contaminants were found to be suitable according to, and in face significantly lower than, the water standards of Tokyo.

Next, Table 2 lists the physical characteristics of the standard and purified water, which were found to be within the acceptable levels according to the water standards of Tokyo. First, the pH level was found to be 7, which again, as shown in Table 2, is within the acceptable range of 5.8 to 8.6. In comparison, the pH level before the purification of the Tokyo water was 8.6. Second, although the water did not have any abnormal smell or taste before the purification of the water, there was no abnormal smell or taste to the purified water. Third, the color and turbidity of the purified water were found to be 1 degree and 0 degrees, respectively, well within the water standards of Tokyo, as shown in Table 2. In contrast, the color and turbidity of the ordinary Tokyo water before purification were found to be 0.5 degrees and 2 degrees, respectively. Finally, the iron content of the purified water was found to be 0.05 mg/l, well below the Tokyo water standard of 0.3 mg/l. Before purification of the water, the iron content of the water was 0.3 mg/l.

Referring next to FIG. 3, shown is an alternative embodiment and use for the present invention, wherein electrically charged wire 25 (i.e., electrically charged within the device of FIG. 1) is coiled around pipe 20. In accordance with the invention, electrical wire 25 is first placed into the device shown in FIGS. 1 and 2 and is electrically charged therein. Once electrically charged, wire 25 may be removed from the purification device and wrapped or coiled around pipe 20 to purify liquids (preferably water) passing therethrough. Preferably, pipe 20 is a metal water pipe that passes water into a house, business or other building or location for drinking, laundry or other purposes. In this embodiment, wire 25 is preferably wrapped in a spiral or coiled fashion around pipe 20. Of course, other methods of placing wire 25 on pipe 20 may be used in accordance with the invention. It is also preferred that wire 25 be wrapped tightly around pipe 20 in close proximity to outer wall 27 of the building structure. Placement of electrically charged wire 25 near outer wall 27 facilitates the purification of the water passing through pipe 20 into the building. This water can then be distributed throughout the building to appliances such as faucets, water heaters, washing machines, etc. Alternatively, wire 25 may be wrapped around other objects to purify or detoxify them or things contained within the object.

Preferably, water purified according to the present invention may be added to gasoline to enhance the performance of an automobile. Specifically, a significant improvement in fuel economy is observed from the addition of this purified water to gasoline. That is, after purifying water using the device and method described above with respect to FIGS. 1-3, adding approximately three (3) parts of this purified water to one thousand (1000) parts gasoline may result in a vehicle capable of traveling 30% further on straight roads and 50% further on sloped roads than a vehicle using gasoline without the purified water.

Similarly, purifying water according to the present invention and using it to water crops also has benefits. While prior art techniques for improving harvest yield of crops involve incorporating additives into irrigation water, such as polymers and gaseous mixtures, the present invention uses water purified according to the present invention, resulting in an increased harvest yield of crops. It has been demonstrated that the use of the purified water instead of regular water results in an approximately thirty percent (30%) increase in the harvest.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. An apparatus for removing harmful substances from a contaminated liquid or object, wherein said apparatus comprises:
a first container;
a second container;
charcoal;
a power source; and
iron sulfide;
wherein said second container is larger than said first container, wherein said charcoal is placed within said first container, wherein said first container, said contaminated object and said iron sulfide are placed within said second container, and wherein said power source generates an electric charge which is transmitted throughout said first and second containers.

2. An apparatus according to claim 1, wherein said first and second containers are conductive.

3. An apparatus according to claim 1, wherein said first container contains a plurality of holes.

4. An apparatus according to claim 1, wherein said second container is sealed with a cover.

5. An apparatus according to claim 1, wherein said second container is insulated from its supporting exterior surfaces.

6. An apparatus according to claim 1, wherein said power source generates a voltage of 10,000 volts.

7. An apparatus according to claim 1, wherein said electric charge is applied for at least 1 hour.

8. An apparatus according to claim 1, wherein said electric charge is applied for at least 5 hours.

9. An apparatus according to claim 1, wherein said electric charge is applied for at least 10 hours.

10. An apparatus according to claim 1, wherein said second container comprises a spout for the removal of said water.

11. A method for the removal of harmful substances from a contaminated liquid or object, wherein said method comprises:
placing charcoal inside a first container;
placing said first container inside a second container;
filling said second container with said contaminated liquid or object;
adding iron sulfide to said second container;
immersing said contaminated liquid or object in said water; and
transmitting an electric charge throughout said water;
wherein said electric charge is generated by an external electric source, wherein said electric charge flows throughout said water within said first and second containers, and wherein said electric charge, said charcoal and said iron sulfide function together to purify said contaminated liquid or object.

12. A method according to claim 11, wherein said first and second containers are conductive.

13. A method according to claim 11, wherein said first container contains a plurality of holes.

14. A method according to claim 11, wherein said second container is sealed with a cover.

15. A method according to claim 11, wherein said second container is insulated from its supporting exterior surfaces.

16. A method according to claim 11, wherein said electric charge is 10,000 volts.

17. A method according to claim 11, wherein said electric charge is applied for at least 1 hour.

18. A method according to claim 11, wherein said electric charge is applied for at least 5 hours.

19. A method according to claim 11, wherein said electric charge is applied for at least 10 hours.

20. A method according to claim 11, wherein said second container comprises a spout for the removal of said water.

21. A method for enhancing the efficiency of gasoline, said method comprising:
purifying water by placing charcoal inside a first container;
placing said first container inside a second container;
filling said second container with water;
transmitting an electric charge throughout said water within said first and second containers; and
combining approximately three parts of said water to one thousand parts of said gasoline.

22. A method according to claim 21, wherein said first and second containers are conductive.

23. A method according to claim 21, wherein said first container contains a plurality of holes.

24. A method according to claim 21, wherein said second container is sealed with a cover.

25. A method according to claim 21, wherein said second container is insulated from its supporting exterior surfaces.

26. A method according to claim 21, wherein said electric charge is 10,000 volts.

27. A method according to claim 21, wherein said electric charge is applied for at least 1 hour.

28. A method according to claim 21, wherein said electric charge is applied for at least 5 hours.

29. A method according to claim 21, wherein said electric charge is applied for at least 10 hours.

30. A method according to claim 21, wherein said second container comprises a spout for the removal of said water.

31. A method for enhancing harvest yields, said method comprising:
purifying water by placing charcoal inside a first container;
placing said first container inside a second container;
filling said second container with water;
providing said purified water to crops; and
transmitting an electric charge throughout said water within said first and second containers.

32. A method according to claim 31, wherein said first and second containers are conductive.

33. A method according to claim 31, wherein said first container contains a plurality of holes.

34. A method according to claim 31, wherein said second container is sealed with a cover.

35. A method according to claim 31, wherein said second container is insulated from its supporting exterior surfaces.

36. A method according to claim 31, wherein said electric charge is 10,000 volts.

37. A method according to claim 31, wherein said electric charge is applied for at least 1 hour.

38. A method according to claim 31, wherein said electric charge is applied for at least 5 hours.

39. A method according to claim 31, wherein said electric charge is applied for at least 10 hours.

40. A method according to claim 31, wherein said second container comprises a spout for the removal of said water.
